(19) United States
(12) Patent Application Publication
(10) Pub. No.: US 2026/0302331 A1
(43) Pub. Date: Oct. 1, 2026

(54) LITHIUM-ION CONDUCTIVE MATERIAL AND SECONDARY BATTERY

(71) Applicants: TOYOTA JIDOSHA KABUSHIKI KAISHA, Toyota-shi, Aichi (JP); DAIKIN INDUSTRIES, LTD., Osaka-shi, Osaka (JP)

(72) Inventors: Kazushige NOMOTO, Sunto-gun, Shizuoka-ken (JP); Hideaki NISHIMURA, Sunto-gun, Shizuoka-ken (JP); Fuminori MIZUNO, Miyoshi-shi, Aichi-ken (JP); Kentaro HIRAGA, Osaka-shi, Osaka-fu (JP); Takaya YAMADA, Osaka-shi, Osaka-fu (JP); Akinari SUGIYAMA, Osaka-shi, Osaka-fu (JP)

(73) Assignees: TOYOTA JIDOSHA KABUSHIKI KAISHA, Toyota-shi, Aichi (JP); DAIKIN INDUSTRIES, LTD., Osaka-shi, Osaka (JP)

(21) Appl. No.: 18/874,203

(22) PCT Filed: Jun. 16, 2023
(86) PCT No.: PCT/JP2023/022430

§ 371 Date: Dec. 12, 2024

(30) Foreign Application Priority Data
Jun. 17, 2022 (JP) 2022-098325

(51) Int. Cl. H01M 10/056; H01M 10/0525

(52) U.S. Cl. CPC H01M 10/056; H01M 10/0525; H01M 2300/0065; H01M 2300/0091

(57) ABSTRACT

Disclosed is a novel lithium-ion conductive material. The lithium-ion conductive material of the present disclosure includes a perfluoropolyether represented by formula (1) below, and LiI dissolved in the perfluoropolyether:

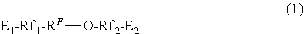

where Rf₁ and Rf₂ are each independently a C₁₋₁₆ divalent alkylene group which may be substituted with one or more fluorine atoms, E₁ and E₂ are each independently a monovalent group selected from the group consisting of a fluorine group, a hydrogen group, a hydroxyl group, an aldehyde group, a carboxylic acid group, a C₁₋₁₀ alkyl ester group, an amide group which may have one or more substituents, and an amino group which may have one or more substituents, and R^{F} is a divalent fluoropolyether group.

### FIELD

The present invention relates to a lithium-ion conductive material and a secondary battery.

### BACKGROUND

Patent Literature 1 discloses mixing a perfluoropolyether as a texturing agent into a solid polymer electrolyte. Furthermore, Patent Literature 2 discloses a perfluoropolyether as an additive component of a non-aqueous electrolytic solution. Patent Literature 3 discloses applying a compound containing a perfluoropolyether group to the surface of an electrode in order to improve the storage stability of the electrode.

### CITATION LIST

### Patent Literature

[PTL 1] Japanese Unexamined PCT Publication (Kohyo) No. 2018-513539
[PTL 2] Japanese Unexamined Patent Publication (Kokai) No. 2018-200866
[PTL 3] Japanese Unexamined Patent Publication (Kokai) No. 2018-147887

### SUMMARY

### Technical Problem

As disclosed in Patent Literature 1 to 3, perfluoropolyethers are used as a variety of battery materials. However, since perfluoropolyethers themselves do not have lithium-ion conductivity, when a perfluoropolyether is used as a battery material, the resistance of the battery is likely to increase. In this regard, a new technology capable of developing lithium-ion conductivity in perfluoropolyethers is needed.

Furthermore, when considering applications to various applications such as batteries, it is necessary that lithium-ion conductive materials have low reactivity with lithium in addition to lithium-ion conductivity.

### Solution to Problem

As means for solving the problem described above, the present disclosure provides the following plurality of aspects.

### <Aspect 1>

A lithium-ion conductive material, comprising a perfluoropolyether represented by formula (1) below, and
LiI dissolved in the perfluoropolyether:

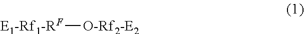

where Rf₁ and Rf₂ are each independently a C₁₋₁₆ divalent alkylene group which may be substituted with one or more fluorine atoms,
E₁ and E₂ are each independently a monovalent group selected from the group consisting of a fluorine group, a hydrogen group, a hydroxyl group, an aldehyde group, a carboxylic acid group, a C₁₋₁₀ alkyl ester group, an amide group which may have one or more substituents, and an amino group which may have one or more substituents, and
R^{F} is a divalent fluoropolyether group.

### <Aspect 2>

The lithium-ion conductive material according to Aspect 1, wherein
R^{F} is a group represented by formula (2):

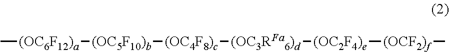

where each R^{Fa} is independently a hydrogen atom, a fluorine atom, or a chlorine atom,
a, b, c, d, e, and f are each independently an integer of 0 to 200,
the sum of a, b, c, d, e, and f is 1 or more,
the order of occurrence of each repeating unit enclosed in parentheses with the subscript a, b, c, d, e, or f is arbitrary in the formula, and
under the proviso that when all R^{Fa} are hydrogen atoms or chlorine atoms, at least one of a, b, c, e, and f is 1 or more.

### <Aspect 3>

The lithium-ion conductive material according to Aspect 2, wherein each R^{Fa} is a fluorine atom.

### <Aspect 4>

The lithium-ion conductive material according to Aspect 3, wherein each R^{F} is independently a group represented by formula (2-1), (2-2), (2-3), (2-4), or (2-5) below:

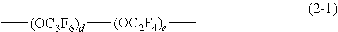

where d is an integer from 1 to 200, and e is 0 or 1;

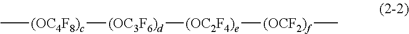

where c and d are each independently an integer of 0 to 30,
e and f are each independently an integer of 1 to 200,
the sum of c, d, e, and f is an integer of 10 to 200, and
the order of occurrence of each repeating unit enclosed in parentheses with the subscript c, d, e or f is arbitrary in the formula;

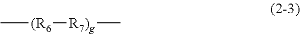

where R₆ is OCF₂ or OC₂F₄,
R₇ is a group selected from OC₂F₄, OC₃F₆, OC₄F₈, OC₅F₁₀, and OC₆F₁₂, or a combination of two or three groups selected from these groups, and
g is an integer of 2 to 100;

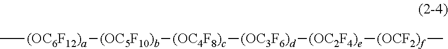

where e is an integer of 1 or more and 200 or less,
a, b, c, d, and f are each independently an integer of 0 or more and 200 or less, and
the order of occurrence of each repeating unit enclosed in parentheses with the subscript a, b, c, d, e, or f is arbitrary in the formula; and

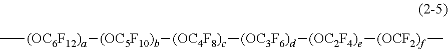

where f is an integer of 1 or more and 200 or less,
a, b, c, d, and e are each independently an integer of 0 or more and 200 or less, and
the order of occurrence of each repeating unit enclosed in parentheses with the subscript a, b, c, d, e, or f is arbitrary in the formula.

### <Aspect 5>

The lithium-ion conductive material according to Aspect 4, wherein each R^{F} is a group represented by formula (2-6) below:

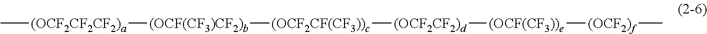

where a, b, c, d, e, and f are each independently an integer of 0 to 200,
the sum of a, b, c, d, e, and f is 1 or more, and
the order of occurrence of each repeating unit enclosed in parentheses with the subscript a, b, c, d, e, or f is arbitrary in the formula.

### <Aspect 6>

The lithium-ion conductive material according to Aspect 4, wherein each R^{F} is a group represented by formula (2-7) below:

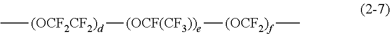

where d, e, and f are each independently an integer of 0 to 200,
the sum of d, e, and f is 1 or more, and
the order of occurrence of each repeating unit enclosed in parentheses with the subscript d, e, or f is arbitrary in the formula.

### <Aspect 7>

The lithium-ion conductive material according to any one of Aspects 1 to 6, wherein E₁-Rf₁ and E₂-Rf₂ are each independently a group selected from the group consisting of —CF₃, —CF₂CF₃, and —CF₂CF₂CF₃.

### <Aspect 8>

A secondary battery, comprising a positive electrode, an electrolyte layer, and a negative electrode, wherein at least one of the positive electrode, the electrolyte layer, and the negative electrode contains the lithium-ion conductive material according to any one of Aspects 1 to 7.

### Effects of Invention

According to the technology of the present disclosure, it is possible to develop lithium-ion conductivity in perfluoropolyethers. The lithium-ion conductive material of the present disclosure has lithium-ion conductivity but low reactivity with lithium.

### BRIEF DESCRIPTION OF DRAWINGS

FIG. 1 schematically shows an example of a secondary battery configuration.

### DESCRIPTION OF EMBODIMENTS

### 1. Lithium-Ion Conductive Material

Embodiments of the technology of the present disclosure will be described below, but the technology of the present disclosure is not limited to the following embodiments. The lithium-ion conductive material of the present disclosure contains a perfluoropolyether represented by the following formula (1), and LiI dissolved in the perfluoropolyether.

### 1.1 Perfluoropolyether (PFPE)

Perfluoropolyethers (PFPE) can serve as texturing agents that change the mechanical properties of battery materials. According to the new findings of the present inventors, in the case where PFPE is mixed with a solid battery material (active materials, solid electrolyte, conductive materials, etc.), for example, the fluidity of the battery material is improved due to the lubricating effect of the PFPE, and the filling rate of the battery material during molding of the battery material is likely to be increased. In addition, since PFPE has a large number of ether bonds, it is considered that PFPE has a high affinity for various battery materials and is likely to be appropriately present along with the battery materials. Furthermore, since the PFPE has insulating properties, for example, by including PFPE in a separator layer (electrolyte layer) of a battery, the voltage resistance of the separator layer can be improved.

The perfluoropolyether is represented by the following formula (1).

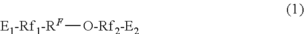

where Rf₁ and Rf₂ are each independently a C₁₋₁₆ divalent alkylene group which may be substituted with one or more fluorine atoms,
E₁ and E₂ are each independently a monovalent group selected from the group consisting of a fluorine group, a hydrogen group, a hydroxyl group, an aldehyde group, a carboxylic acid group, a C₁₋₁₀ alkyl ester group, an amide group which may have one or more substituents, and an amino group which may have one or more substituents, and
R^{F} is a divalent fluoropolyether group.

In the above formula (1), Rf₁ and Rf₂ each independently represent a C₁₋₁₆ divalent alkylene group optionally substituted with one or more fluorine atoms.

In one aspect, the “C₁₋₁₆ divalent alkylene group” in the above-mentioned C₁₋₁₆ divalent alkylene group optionally substituted by one or more fluorine atoms may be a straight chain or a branched chain, preferably a straight chain or branched chain C₁₋₆ alkylene group, particularly a C₁₋₃ alkylene group, more preferably a straight chain C₁₋₆ alkylene group, and particularly a C₁₋₃ alkylene group.

In an aspect, the “C₁₋₁₆ divalent alkylene” in the above-mentioned C₁₋₁₆ divalent alkylene group optionally substituted by one or more fluorine atoms may be linear or branched, and is preferably a linear or branched C₁₋₆ fluoroalkylene group, in particular a C₁₋₃ fluoroalkylene group, specifically, —CF₂CH₂— and —CF₂CF₂CH₂—, and more preferably a linear C₁₋₆ perfluoroalkylene group, in particular a C₁₋₃ perfluoroalkylene group, and specifically, a group selected from the group consisting of —CF₂—, —CF₂CF₂— and —CF₂CF₂CF₂—.

In the above formula (1), E₁ and E₂ are each independently a monovalent group selected from the group consisting of a fluorine group, a hydrogen group, a hydroxyl group, an aldehyde group, a carboxylic acid group, a C₁₋₁₀ alkyl ester group, an amide group which may have one or more substituents, and an amino group which may have one or more substituents.

The PFPE has low reactivity with lithium. In particular, when the PFPE has a non-polar group as an end group, the reactivity between the PFPE and lithium can be further suppressed. In this regard, the E₁ and E₂ are each independently preferably a fluorine group. In an aspect, E₁-Rf₁ and E₂-Rf₂ may each independently be a group selected from the group consisting of —CF₃, —CF₂CF₃, and —CF₂CF₂CF₃.

In formula (1) described above, each R^{F} is independently a divalent fluoropolyether group.
each R^{F} is preferably a group represented by formula (2):

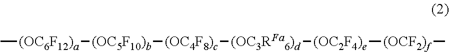

where each R^{Fa} is independently a hydrogen atom, a fluorine atom, or a chlorine atom,
a, b, c, d, e, and f are each independently an integer of 0 to 200,
the sum of a, b, c, d, e, and f is 1 or more,
the order of occurrence of each repeating unit enclosed in parentheses with the subscript a, b, c, d, e, or f is arbitrary in the formula, and
under the proviso that when all R^{Fa} are hydrogen atoms or chlorine atoms, at least one of a, b, c, e, and f is 1 or more.
R^{Fa} is preferably a hydrogen atom or a fluorine atom, and more preferably a fluorine atom.
a, b, c, d, e and f may preferably each independently be an integer from 0 to 100.

The sum of a, b, c, d, e, and f is preferably 5 or more, more preferably 10 or more, and may be, for example, 15 or more or 20 or more. The sum of a, b, c, d, e, and f is preferably 200 or less, more preferably 100 or less, and further preferably 60 or less, and may be, for example, 50 or less or 30 or less.

These repeating units may be linear or branched. For example:
—(OC₆F₁₂)— may be any of —(OCF₂CF₂CF₂CF₂CF₂CF₂)—, —(OCF(CF₃)CF₂CF₂CF₂CF₂)—, —(OCF₂CF(CF₃)CF₂CF₂CF₂)—, —(OCF₂CF₂CF(CF₃)CF₂CF₂)—, —(OCF₂CF₂CF₂CF(CF₃)CF₂)—, and —(OCF₂CF₂CF₂CF₂CF(CF₃))—.
—(OC₅F₁₀)— may be any of —(OCF₂CF₂CF₂CF₂CF₂CF₂)—, —(OCF(CF₃)CF₂CF₂CF₂CF₂)—, —(OCF₂CF(CF₃)CF₂CF₂)—, —(OCF₂CF₂CF(CF₃)CF₂)—, and —(OCF₂CF₂CF₂CF(CF₃))—.
—(OC₄F₈)— may be any of —(OCF₂CF₂CF₂CF₂)—, —(OCF(CF₃)CF₂CF₂)—, —(OCF₂CF(CF₃)CF₂)—, —(OCF₂CF₂CF(CF₃))—, —(OC(CF₃)₂CF₂)—, —(OCF₂C(CF₃)₂)—, —(OCF(CF₃)CF(CF₃))—, —(OCF(C₂F₅)CF₂)—, and —(OCF₂CF(C₂F₅))—.
—(OC₃F₆)— (i.e., the case in which Ra is a fluorine atom in formula (2) above) may be any of —(OCF₂CF₂CF₂)—, —(OCF(CF₃)CF₂)—, and —(OCF₂CF(CF₃))—.
—(OC₂F₄)— may be either —(OCF₂CF₂)— or —(OCF(CF₃))—.

In an aspect, each R^{F} may independently be a group represented by any one of the following formulas (2-1) to (2-5).

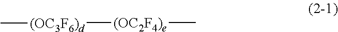

where d is an integer from 1 to 200, and e is 0 or 1.

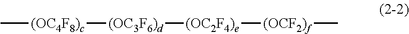

where c and d are each independently an integer of 0 to 30,
e and f are each independently an integer of 1 or more and 200 or less,
the sum of c, d, e, and f is 2 or more, and
the order of occurrence of each repeating unit enclosed in parentheses with the subscript c, d, e or f is arbitrary in the formula.

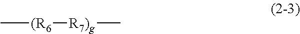

where R₆ is OCF₂ or OC₂F₄,
R₇ is a group selected from OC₂F₄, OC₃F₆, OC₄F₈, OC₅F₁₀, and OC₆F₁₂, or a combination of two or three groups selected from these groups, and
g is an integer of 2 to 100.

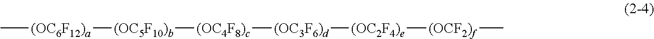

where e is an integer of 1 or more and 200 or less,
a, b, c, d, and f are each independently an integer of 0 or more and 200 or less, and
the order of occurrence of each repeating unit enclosed in parentheses with the subscript a, b, c, d, e, or f is arbitrary in the formula.

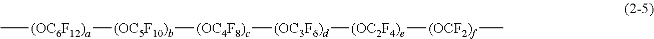

where f is an integer of 1 or more and 200 or less,
a, b, c, d, and e are each independently an integer of 0 or more and 200 or less, and
the order of occurrence of each repeating unit enclosed in parentheses with the subscript a, b, c, d, e, or f is arbitrary in the formula.

In formula (2-1) above, d is preferably an integer of 5 to 200, more preferably 10 to 100, further preferably 15 to 50, and is, for example, an integer of 25 to 35. Formula (2-1) above is preferably a group represented by —(OCF₂CF₂CF₂)_{d}— or —(OCF(CF₃)CF₂)_{d}—, and more preferably a group represented by —(OCF₂CF₂CF₂)_{d}—. In an aspect, e is 0. In another aspect, e is 1.

In formula (2-2) above, e and f are each independently an integer of preferably 5 to 200, and more preferably 10 to 200. The sum of c, d, e, and f is preferably 5 or more, more preferably 10 or more, and may be, for example, 15 or more or 20 or more. In an aspect, formula (2-2) above is preferably a group represented by —(OCF₂CF₂CF₂CF₂)_{c}—(OCF₂CF₂CF₂)_{d}—(OCF₂CF₂)ₑ—(OCF₂)_{f}—. In another aspect, formula (2-2) may be a group represented by —(OC₂F₄)ₑ—(OCF₂)_{f}—.

In formula (2-3) above, R⁶ is preferably OC₂F₄. In formula (2-3) above, R⁷ is preferably a group selected from OC₂F₄, OC₃F₆, and OC₄F₈, or a combination of two or three groups independently selected from these groups, and is more preferably a group selected from OC₃F₆ and OC₄F₈. The combination of two or three groups independently selected from OC₂F₄, OC₃F₆ and OC₄F₈ is not particularly limited, and examples thereof include-OC₂F₄OC₃F₆—, —OC₂F₄OC₄F₈—, —OC₃F₆OC₂F₄—, —OC₃F₆OC₃F₆—, —OC₃F₆OC₄F₈—, —OC₄F₈OC₄F₈—, —OC₄F₈OC₃F₆—, —OC₄F₈OC₂F₄—, —OC₂F₄OC₂F₄OC₃F₆—, —OC₂F₄OC₂F₄OC₄F₈—, —OC₂F₄OC₃F₆OC₂F₄—, —OC₂F₄OC₃F₆OC₃F₆—, —OC₂F₄OC₄F₈OC₂F₄—, —OC₃F₆OC₂F₄OC₂F₄—, —OC₃F₆OC₂F₄OC₃F₆—, —OC₃F₆OC₃F₆OC₂F₄—, and —OC₄F₈OC₂F₄OC₂F₄—. In formula (2-3) above, g is preferably an integer of 3 or more, and more preferably 5 or more. g is preferably an integer of 50 or less. In formula (2-3) above, OC₂F₄, OC₃F₆, OC₄F₈, OC₅F₁₀, and OC₆F₁₂ may be either linear or branched, and are preferably linear. In this aspect, formula (2-3) above is preferably —(OC₂F₄—OC₃F₆)_{g}— or —(OC₂F₄—OC₄F₈)_{g}—.

In formula (2-4) above, e is preferably an integer of 1 or more and 100 or less, and more preferably an integer of 5 or more and 100 or less. The sum of a, b, c, d, e, and f is preferably 5 or more, more preferably 10 or more, for example, 10 or more and 100 or less.

In formula (2-5) above, f is preferably an integer of 1 or more and 100 or less, and more preferably an integer of 5 or more and 100 or less. The sum of a, b, c, d, e, and f is preferably 5 or more, more preferably 10 or more, for example, 10 or more and 100 or less.

In an aspect, each R^{F} is a group represented by formula (2-1).

In an aspect, each R^{E} is a group represented by formula (2-2).

In an aspect, each R^{F} is a group represented by formula (2-3).

In an aspect, each R^{F} is a group represented by formula (2-4).

In an aspect, each R^{F} is a group represented by formula (2-5).

In R^{F}, the ratio of e to f (hereinafter referred to as the “e/f ratio”) may be 0.5 to 4, preferably 0.6 to 3, more preferably 0.7 to 2, and further preferably 0.8 to 1.4. By setting the e/f ratio to 4 or less, lubricity and chemical stability are further improved. The smaller the e/f ratio, the greater lubricity is improved. Conversely, by setting the e/f ratio to 0.5 or more, the stability of the compound can be further improved. The greater the e/f ratio, the more the stability of the fluoropolyether structure is improved. In this case, the value of f is preferably 0.8 or more.

In an aspect, each R^{F} may be a group represented by the following formula (2-6):

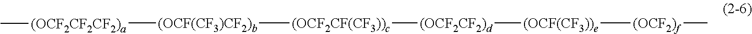

where a, b, c, d, e, and f are each independently an integer of 0 to 200,
the sum of a, b, c, d, e, and f is 1 or more, and
the order of occurrence of each repeating unit enclosed in parentheses with the subscript a, b, c, d, e, or f is arbitrary in the formula.

In an embodiment, each R^{F} may be a group represented by the following formula (2-7):

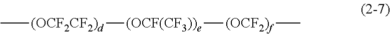

where d, e, and f are each independently an integer of 0 to 200,
the sum of d, e, and f is 1 or more, and
the order of occurrence of each repeating unit enclosed in parentheses with the subscript d, e, or f is arbitrary in the formula.

In R^{F}, the ratio of d to f (hereinafter referred to as “d/f ratio”) may be 0.5 to 4, preferably 0.6 to 3, more preferably 0.7 to 2, and further preferably 0.8 to 1.4. By setting the d/f ratio to 4 or less, lubricity and chemical stability are further improved. The smaller the d/f ratio, the greater lubricity is improved. Conversely, by setting the d/f ratio to 0.5 or more, the stability of the compound can be further improved. The greater the d/f ratio, the more the stability of the fluoropolyether structure is improved. In this case, the value of f is preferably 0.8 or more.

According to the findings of the present inventors, when the number of carbon atoms of the perfluorooxyalkylene units in PFPE is 2 or less, the solubility of the lithium salt in the PFPE is further increased. Specifically, when R^{F} in the PFPE is represented by formula (2-7) above, a greater effect can be expected. When R^{F} is represented by formula (2-7) above, the number of ether bonds in the PFPE increases. It is considered that when the number of ether bonds in the PFPE is large, lithium-ions are more easily coordinated to the PFPE. This is considered to improve the solubility of the lithium salt in PFPE.

In the fluoropolyether group-containing compound described above, the number average molecular weight of each R^{F} portion is not particularly limited, and is, for example, 500 to 30,000, preferably 1,500 to 30,000, and more preferably 2,000 to 10,000. In the present description, the number average molecular weight of R^{F} is a value measured by 1F-NMR.

### 1.2 LiI Dissolved in PFPE

According to the findings of the present inventors, since PFPE itself does not have lithium-ion conductivity, when PFPE is mixed with a battery material, the PFPE is likely to cause battery resistance. In response to this problem, the present inventors believed that it would be possible to cause the PFPE to exhibit lithium-ion conductivity by dissolving a lithium salt in the PFPE.

Examples of lithium salts which can be used as a battery material include halides (LiF, LiCl, LiBr, LiI) and imide salts (LiTFSI). According to the findings of the present inventors, among many lithium salts, LiI is particularly soluble in the PFPE described above and can easily cause lithium-ion conductivity to be exhibited by the PFPE. Iodine has a low electronegativity as compared to fluorine, chlorine, and bromine. Specifically, LiI has a property of easily dissociating lithium-ions as compared to LiF, LiCl, and LiBr, and is therefore considered to have a high solubility in the PFPE described above.

The concentration of LiI in the PFPE is not particularly limited and may be appropriately adjusted in accordance with the desired lithium-ion conductivity. For example, the molar concentration of LiI in the PFPE may be 0.01M or more, 0.02M or more, 0.03M or more, 0.04M or more, or 0.05M or more, and may be less than or equal to the saturated concentration.

Whether the LiI is dissolved in the PFPE can be determined by analyzing the components (elements, ions) dissolved in the PFPE. LiI is not necessarily completely dissociated into lithium-ions and iodine ions in PFPE, and may be present as some sort of association or the like. In either case, by dissolving LiI in the PFPE, lithium-ion conductivity can be exhibited by the PFPE.

As used herein, “LiI dissolved in PFPE” is not limited to a state in which LiI, a lithium salt, is added to the PFPE and dissolved therein, but also includes a state in which LiI is dissolved in the PFPE as a result of adding a Li source and an I source separately to the PFPE and dissolving them.

### 1.3 Other Components

The lithium-ion conductive material of the present disclosure may contain other additive components in addition to the PFPE and LiI described above. Various other additive components can be adopted in accordance with the desired performance.

### 2. Secondary Battery

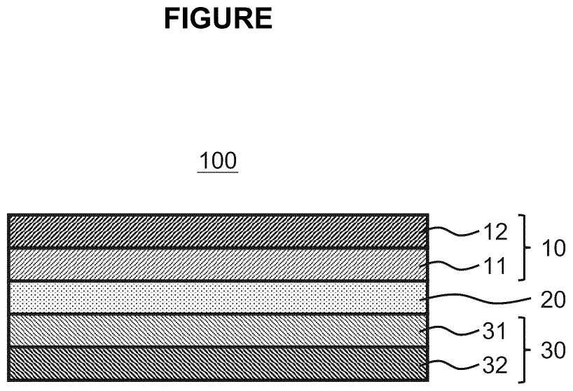

The technology of the present disclosure also includes an aspect of a secondary battery comprising the lithium-ion conductive material described above. Specifically, as shown in FIG. 1, a secondary battery 100 according to an embodiment comprises a positive electrode 10, an electrolyte layer 20, and a negative electrode 30, and at least one of the positive electrode 10, the electrolyte layer 20, and the negative electrode 30 contains the lithium-ion conductive material of the present disclosure described above.

### 2.1 Positive Electrode

The positive electrode 10 may be any electrode which is capable of functioning properly as a positive electrode of a secondary battery, and the configuration thereof is not particularly limited. As shown in FIG. 1, the positive electrode 10 may comprise a positive electrode active material layer 11 and a positive electrode current collector 12.

### 2.1.1 Positive Electrode Active Material Layer

The positive electrode active material layer 11 contains at least a positive electrode active material, and may further contain an electrolyte, a conductive aid, a binder, etc. The positive electrode active material layer 11 may also contain various additives. The content of each component of the positive electrode active material layer 11 may be appropriately determined in accordance with the desired battery performance. For example, when the entirety of the positive electrode active material layer 11 (total solid content) is 100 mass %, the content of the positive electrode active material may be 40 mass % or more, 50 mass % or more, 60 mass % or more, or 70 mass % or more, and 100 mass % or less, or 90 mass % or less. The shape of the positive electrode active material layer 11 is not particularly limited, and may be, for example, a sheet-like positive electrode active material layer having a substantially flat surface. The thickness of the positive electrode active material layer 11 is not particularly limited, and may be, for example, 0.1 μm or more, 1 μm or more, or 10 μm or more, and may be 2 mm or less, 1 mm or less, or 500 μm or less.

As the positive electrode active material, a material which is known as a positive electrode active material for secondary batteries may be used. Among known active materials, a material having a relatively noble potential (charge/discharge potential) for absorbing and releasing lithium ions can be used as the positive electrode active material, and a material having a relatively basic potential can be used as the negative electrode active material, which will be described later. The positive electrode active material may be at least one selected from, for example, various lithium-containing compounds, elemental sulfur, and sulfur compounds. The lithium-containing compound as the positive electrode active material may be any of various lithium-containing oxides such as lithium cobalt oxide, lithium nickel oxide, Li_{1±α}Ni_{1/3}Co_{1/3}Mn_{1/3}O_{2±δ}, lithium manganate, spinel-based lithium compounds (such as Li₁₊ₓMn_{2-x-y}M_{y}O₄ (where M is one or more selected from Al, Mg, Co, Fe, Ni, and Zn) substituted Li—Mn spinels), lithium titanate, and lithium metal phosphate (such as LiMPO₄, where M is one or more selected from Fe, Mn, Co, and Ni). In particular, when the positive electrode active material contains a lithium-containing oxide containing at least Li, at least one of Ni, Co, and Mn, and O as constituent elements, a greater effect can be expected. These positive electrode active materials may be used alone or in combination of two or more types thereof.

The shape of the positive electrode active material may be any shape which is common for the positive electrode active material of a battery. The positive electrode active material may be, for example, particulate. The positive electrode active material may be hollow, have voids, or be porous. The positive electrode active material may be primary particles or secondary particles formed by agglomeration of a plurality of primary particles. The average particle diameter D50 of the positive electrode active material may be, for example, 1 nm or more, 5 nm or more, or 10 nm or more, and may be 500 μm or less, 100 μm or less, 50 μm or less, or 30 μm or less. Note that as used herein, the average particle diameter D50 is the particle diameter (median diameter) at an integrated value of 50% in a volume-based particle size distribution obtained by a laser diffraction/scattering method.

A protective layer containing an ion-conductive oxide may be formed on the surface of the positive electrode active material. As a result, the reaction between the positive electrode active material and a sulfide (for example, a sulfide solid electrolyte, which will be described later) can more easily be suppressed. Examples of ion-conductive oxides include Li₃BO₃, LiBO₂, Li₂CO₃, LiAlO₂, Li₄SiO₄, Li₃SiO₃, Li₃PO₄, Li₂SO₄, Li₂TiO₃, Li₄Ti₅O₁₂, Li₂Ti₂O₅, Li₂ZrO₃, LiNbO₃, Li₂MoO₄, and Li₂WO₄. The ion-conductive oxide may have some elements substituted with doping elements such as P and B. The coverage (area ratio) of the protective layer to the surface of the positive electrode active material may be, for example, 70% or more, 80% or more, or 90% or more. The thickness of the protective layer may be, for example, 0.1 nm or more or 1 nm or more, and may be 100 nm or less or 20 nm or less.

The electrolyte which can be contained in the positive electrode active material layer 11 may be a solid electrolyte, a liquid electrolyte (electrolytic solution), or a combination of these. In particular, when the positive electrode active material layer 11 contains at least a solid electrolyte as the electrolyte, a greater effect is likely to be obtained. Furthermore, when the positive electrode active material layer 11 contains, as the electrolyte, at least a solid electrolyte and the lithium-ion conductive material of the present disclosure described above, a greater effect is likely to be obtained.

The solid electrolyte may be any solid electrolyte which is known for secondary batteries. The solid electrolyte may be an inorganic solid electrolyte or an organic polymer electrolyte. In particular, inorganic solid electrolytes have excellent ionic conductivity and heat resistance. Examples of inorganic solid electrolytes include oxide solid electrolytes such as lithium lanthanum zirconate, LiPON, Li_{1+X}Al_{X}Ge_{2-X} (PO₄)₃, Li—SiO-based glasses, and Li—Al—S—O-based glasses; and sulfide solid electrolytes such as Li₂S—P₂S₅, Li₂S—SiS₂, LiI—Li₂S—SiS₂, LiI—Si₂S—P₂S₅, Li₂S—P₂S₅—LiI—LiBr, LiI—Li₂S—P₂S₅, LiI—Li₂S—P₂O₅, LiI—Li₃PO₄—P₂S₅, and Li₂S—P₂S₅—GeS. In particular, the performance of the sulfide solid electrolyte, particularly the sulfide solid electrolyte containing at least Li, S and P as constituent elements, is high. The solid electrolyte may be amorphous or crystalline. The solid electrolyte may be, for example, in the form of particles. One type of solid electrolyte may be used alone, or two or more types thereof may be used in combination.

The electrolytic solution may contain predetermined carrier ions (for example, lithium ions). The electrolytic solution may be, for example, a non-aqueous electrolytic solution. The composition of the electrolytic solution may be the same as the known composition of the electrolytic solution of the secondary battery. For example, the electrolytic solution may be a carbonate-based solvent in which a lithium salt is dissolved at a predetermined concentration. Examples of carbonate-based solvents include fluoroethylene carbonate (FEC), ethylene carbonate (EC), and dimethyl carbonate (DMC). Examples of lithium salts include LiPF₆.

Examples of the conductive aid which may be contained in the positive electrode active material layer 11 include carbon materials such as vapor-grown carbon fiber (VGCF), acetylene black (AB), Ketjen black (KB), carbon nanotubes (CNT), and carbon nanofibers (CNF); and metal materials such as nickel, aluminum, and stainless steel. The conductive aid may be, for example, particulate or fibrous, and the size thereof is not particularly limited. One type of conductive aid may be used alone, or two or more types thereof may be used in combination.

Examples of the binder that may be contained in the positive electrode active material layer 11 include butadiene rubber (BR)-based binders, butylene rubber (IIR)-based binders, acrylate butadiene rubber (ABR)-based binders, styrene butadiene rubber (SBR)-based binders, polyvinylidene fluoride (PVdF)-based binders, polytetrafluoroethylene (PTFE)-based binders, and polyimide (PI)-based binders. One type of binder may be used alone, or two or more types thereof may be used in combination.

### 2.1.2 Positive Electrode Current Collector

As shown in FIG. 1, the positive electrode 10 may comprise a positive electrode current collector 12 which contacts the positive electrode active material layer 11. The positive electrode current collector 12 may be any which is commonly used as the positive electrode current collector of a battery. The positive electrode current collector 12 may be in the form of a foil, a plate, a mesh, a punched metal, or a foam. The positive electrode current collector 12 may be composed of a metal foil or a metal mesh. In particular, metal foils are excellent in terms of ease of handling. The positive electrode current collector 12 may be composed of a plurality of foils. Examples of metals for constituting the positive electrode current collector 12 include Cu, Ni, Cr, Au, Pt, Ag, Al, Fe, Ti, Zn, Co, and stainless steel. In particular, the positive electrode current collector 12 may contain Al from the viewpoint of ensuring oxidation resistance. The positive electrode current collector 12 may have some type of coating layer on the surface thereof for the purpose of adjusting resistance. The positive electrode current collector 12 may be a metal foil or a substrate on which the metal described above is plated or vapor-deposited. When the positive electrode current collector 12 is composed of a plurality of metal foils, some layers may be present between the plurality of metal foils. The thickness of the positive electrode current collector 12 is not particularly limited. For example, it may be 0.1 μm or more or 1 μm or more, and 1 mm or less or 100 μm or less.

### 2.2 Electrolyte Layer

The electrolyte layer 20 is arranged between the positive electrode 10 and the negative electrode 30 and can function as a separator. The electrolyte layer 20 contains at least an electrolyte, and may further contain a binder or the like as desired. The electrolyte layer 20 may further contain other various additives. The content of each component in the electrolyte layer 20 is not particularly limited, and may be appropriately determined in accordance with the desired battery performance. The shape of the electrolyte layer 20 is not particular limited, and it may be, for example, a sheet having a substantially flat surface. The thickness of the electrolyte layer 20 is not particularly limited, and may be, for example, 0.1 μm or more or 1 μm or more, and may be 2 mm or less or 1 mm or less.

### 2.2.1 Electrolyte

The electrolyte contained in the electrolyte layer 20 may be appropriately selected from those exemplified as electrolytes which may be contained in the positive electrode active material layer described above. In particular, an electrolyte layer 20 containing a solid electrolyte, in particular, a sulfide solid electrolyte, and further a sulfide solid electrolyte containing at least Li, S, and P as constituent elements, has high performance. When the electrolyte layer 20 contains, as the electrolyte, at least a solid electrolyte and the lithium-ion conductive material of the present disclosure described above, a greater effect is likely to be obtained. When the electrolyte is a solid electrolyte, the solid electrolyte may be amorphous or crystalline. When the electrolyte is a solid electrolyte, the solid electrolyte may be, for example, particulate. One type of sulfide solid electrolyte may be used alone, or two or more types thereof may be used in combination.

### 2.2.2 Binder

The binder which can be contained in the electrolyte layer 20 may be appropriately selected from, for example, those exemplified as binders which can be contained in the positive electrode active material layer described above.

### 2.3 Negative Electrode

The negative electrode 30 may be any electrode which capable of functioning properly as a negative electrode of the secondary battery, and the configuration thereof is not particularly limited. As shown in FIG. 1, the negative electrode 30 may contain a negative electrode active material layer 31 and a negative electrode current collector 32.

### 2.3.1 Negative Electrode Active Material Layer

The negative electrode active material layer 31 contains at least a negative electrode active material, and may further contain an electrolyte, a conductive aid, a binder, etc. The negative electrode active material layer 31 may also contain various additives. The content of each component in the negative electrode active material layer 31 may be appropriately determined in accordance with the desired battery performance. For example, when the entire negative electrode active material layer 31 (total solid content) is 100 mass %, the content of the negative electrode active material may be 40 mass % or more, 50 mass % or more, 60 mass % or more, or 70 mass % or more, and 100 mass % or less, or 90 mass % or less. The shape of the negative electrode active material layer 31 is not particularly limited, and may be, for example, a sheet-like negative electrode active material layer having a substantially flat surface. The thickness of the negative electrode active material layer 31 is not particularly limited, and may be, for example, 0.1 μm or more, 1 μm or more, or 10 μm or more, and may be 2 mm or less, 1 mm or less, or 500 μm or less.

As the negative electrode active material, various substances which have a potential (charge/discharge potential) for absorbing and releasing lithium ions that is lower than that of the positive electrode active material can be adopted. For example, the negative electrode active material may be at least one selected from silicon-based active materials such as Si, Si alloys, and silicon oxide; carbon-based active materials such as graphite and hard carbon; various oxide-based active materials such as lithium titanate; metallic lithium, lithium alloys, and the like. One type of negative electrode active material may be used alone, or two or more types thereof may be used in combination.

The shape of the negative electrode active material may be a shape which is generally used in the negative electrode active material for a battery. The negative electrode active material may be, for example, particulate. The negative electrode active material may be hollow, may have voids, or may be porous. The negative electrode active material may be primary particles, or may be secondary particles formed by agglomeration of a plurality of primary particles. The average particle diameter D50 of the negative electrode active material may be, for example, 1 nm or more, 5 nm or more, or 10 nm or more, and may be 500 μm or less, 100 μm or less, 50 μm or less, or 30 μm or less. Alternatively, the negative electrode active material may be in the form of a sheet (foil or film) such as a lithium foil. Specifically, the negative electrode active material layer 31 may be composed of a sheet of the negative electrode active material.

The electrolyte which may be contained in the negative electrode active material layer 31 may be a solid electrolyte, a liquid electrolyte (electrolytic solution), or a combination of these. In particular, when the negative electrode active material layer 31 contains at least a solid electrolyte as an electrolyte, a high effect can easily be obtained. Furthermore, when the negative electrode active material layer 31 contains at least a solid electrolyte and the lithium-ion conductive material of the present disclosure as the electrolyte, an even greater effect can easily be obtained. The negative electrode active material layer 31 may contain a solid electrolyte, particularly a sulfide solid electrolyte, and further, among them, a sulfide solid electrolyte containing Li₂S—P₂S₅. Examples of the conductive aid which may be contained in the negative electrode active material layer 31 include the carbon materials described above and the metal materials described above. The binder which may be contained in the negative electrode active material layer 31 may be appropriately selected from, for example, those exemplified as binders which may be contained in the positive electrode active material layer 11 described above.

### 2.3.2 Negative Electrode Current Collector

As shown in FIG. 1, the negative electrode 30 may contain a negative electrode current collector 32 which is in contact with the negative electrode active material layer 31. The negative electrode current collector 32 may be any which is commonly used as the negative electrode current collector for a battery. The negative electrode current collector 32 may be in the form of a foil, a plate, a mesh, a punched metal, or a foam. The negative electrode current collector 32 may be a metal foil or a metal mesh, or may be a carbon sheet. In particular, metal foils are excellent in terms of ease of handling. The negative electrode current collector 32 may be composed of a plurality of foils or sheets. Examples of metals constituting the negative electrode current collector 32 include Cu, Ni, Cr, Au, Pt, Ag, Al, Fe, Ti, Zn, Co, and stainless steel. In particular, from the viewpoint of ensuring reduction resistance and preventing alloying with lithium, the negative electrode current collector 32 may contain at least one metal selected from Cu, Ni, and stainless steel. The negative electrode current collector 32 may have some type of coating layer on the surface thereof for the purpose of adjusting resistance. Furthermore, the negative electrode current collector 32 may be a metal foil or a substrate on which the metal described above is plated or vapor-deposited. When the negative electrode current collector 32 is composed of a plurality of metal foils, some sort of layer may be present between the plurality of metal foils. The thickness of the negative electrode current collector 32 is not particularly limited. For example, it may be 0.1 μm or more or 1 μm or more, and may be 1 mm or less or 100 μm or less.

### 2.4 Lithium-Ion Conductive Material

In the secondary battery 100, the lithium-ion conductive material of the present disclosure is contained in at least one of the positive electrode 10, the electrolyte layer 20, and the negative electrode 30. The lithium-ion conductive material may fill at least a part of the voids (gaps between solid materials) present in the positive electrode 10, the electrolyte layer 20, and the negative electrode 30. In the secondary battery 100, the sulfide solid electrolyte may be contained in at least one of the positive electrode 10, the electrolyte layer 20, and the negative electrode 30, and a part of the lithium-ion conductive material of the present disclosure may be in contact with a part of the sulfide solid electrolyte. Since PFPE having low reactivity with the sulfide solid electrolyte is used in the secondary battery 100, even if the PFPE comes into contact with the sulfide solid electrolyte, change or deterioration of the sulfide solid electrolyte is unlikely to occur, and the high ionic conductivity of the sulfide solid electrolyte is likely to be maintained.

### 2.5 Other Configurations

In the secondary battery 100, each of the components described above may be housed inside an exterior body. Any known exterior body for a battery can be used as the exterior body. Furthermore, a plurality of secondary batteries 100 may be electrically connected in any manner and stacked in any manner to form a battery pack. In this case, the battery pack may be housed inside a known battery case. The secondary battery 100 may also comprise other obvious components such as necessary terminals. Examples of the shape of the secondary battery 100 include a coin type, a laminate type, a cylindrical type, and a rectangular type.

### 2.6 Secondary Battery Production Method

The secondary battery 100 can be produced by adopting a known method. For example, it can be produced as follows. However, the production method for the secondary battery 100 is not limited to the following method, and each layer may be formed by, for example, dry molding or the like.
(1) The negative electrode active material constituting the negative electrode active material layer is dispersed in a solvent to obtain a negative electrode slurry. The solvent used in this case is not particularly limited, and may be water or any of various organic solvents. Thereafter, the negative electrode slurry is applied to the surface of a negative electrode current collector or an electrolyte layer as described below using a doctor blade or the like, and then dried to form a negative electrode active material layer on the surface of the negative electrode current collector or the electrolyte layer, thereby forming a negative electrode. The negative electrode active material layer may be press-molded.
(2) The positive electrode active material constituting the positive electrode active material layer is dispersed in a solvent to obtain a positive electrode slurry. The solvent used in this case is not particularly limited, and water or any of various organic solvents can be used. Thereafter, the positive electrode slurry is applied to the surface of a positive electrode current collector or an electrolyte layer as described below using a doctor blade or the like, and then dried to form a positive electrode active material layer on the surface of the positive electrode current collector or the electrolyte layer, thereby forming a positive electrode. The positive electrode active material layer may be press molded.
(3) Each layer is laminated so that the electrolyte layer is interposed between the negative electrode and the positive electrode to obtain a laminate having a negative electrode current collector, a negative electrode active material layer, an electrolyte layer, a positive electrode active material layer, and a positive electrode current collector in this order. The electrolyte layer may be obtained by molding an electrolyte mixture containing, for example, an electrolyte and a binder, or may be obtained by press-molding. Alternatively, when producing a liquid electrolyte battery, a separator which serves as an electrolyte layer may be interposed between the negative electrode active material layer and the positive electrode active material layer. The laminate may be further press molded. Other members such as terminals are attached to the laminate as needed.
(4) The laminate is optionally housed together with an electrolyte in a battery case and sealed to obtain a secondary battery. The timing for incorporating the lithium-ion conductive material of the present disclosure into at least one of the positive electrode, the electrolyte layer, and the negative electrode is not particularly limited, and may be, for example, one or more of steps (1) to (3) above, or may be when the laminate is housed in a battery case or at any time thereafter.

### Examples

The technology of the present disclosure will be described in more detail below with reference to Examples, but the technology of the present disclosure is not limited to the following Examples.

### 1. Preparation of Lithium-Ion Conductive Material

An evaluation material was prepared by mixing PFPE (I) or (II) as a perfluoropolyether and any one of lithium trifluoromethanesulfonylimide (LiTFSI), lithium fluoride (LiF) and lithium iodide (LiI) as a lithium salt. The concentration of the lithium salt relative to the PFPE is as shown in Table 1 below. PFPE (I) is a liquid having a chemical structure represented by the following formula (I) (where m/n is 1.2, the number average molecular weight is 5120, and the terminal R has CF₃ and CF₂CF₃ at an average ratio of 1:0.17), and PFPE (II) is a liquid having a chemical structure represented by the following formula (II) (where m/n is 1.3, and the number average molecular weight is 4238).

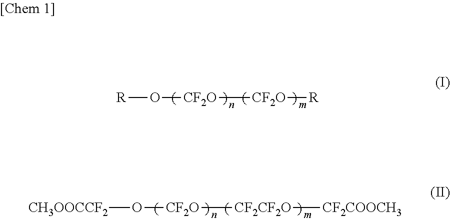

### 2. Measurement of Ionic Conductivity

The lithium-ion conductivity of each evaluation material was confirmed by measuring the resistance by the AC impedance method.

3. Evaluation of Reactivity with Lithium

PFPE (I) or (II) was brought into contact with a metallic lithium foil to check for discoloration. If discoloration was observed, it was determined that the PFPE had reacted with the lithium.

### 4. Evaluation Results

The evaluation results are shown in Table 1 below.

TABLE 1

| | | Lithium salt | | Ionic | |
|---|---|---|---|---|---|
| | PFPE | | Density | conductivity | Reactivity |
| | Type | Type | (M) | (nS/cm) | with Li |
| Comp Ex 1 | PFPE (I) | LITFSI | 0.05 | None | None |
| Comp Ex 2 | PFPE (I) | LIF | 0.05 | None | None |
| Comp Ex 3 | PFPE (II) | LITFSI | 0.05 | None | None |
| Comp Ex 4 | PFPE (II) | LIF | 0.05 | None | None |
| Ex 1 | PFPE (I) | LiI | 0.01 | 1.2 | None |
| Ex 2 | PFPE (I) | LiI | 0.05 | 2.3 | None |
| Ex 3 | PFPE (II) | LiI | 0.01 | 1.0 | None |
| Ex 4 | PFPE (II) | LiI | 0.05 | 2.3 | None |

The results shown in Table 1 reveal the following:
(1) In Comparative Examples 1 to 4, since LiTFSI or LiF was used as the lithium salt, the lithium salt could not be suitably dissolved in the PFPE, whereby lithium-ion conductivity could not be exhibited by the PFPE.
(2) In Examples 1 to 4, since LiI was used as the lithium salt, the LiI could be dissolved in PFPE (I) or (II). As a result, lithium-ion conductivity could be exhibited by the PFPE. Furthermore, since no reaction between the PFPE and the lithium was observed, the PFPE was suitable as a lithium-ion conductive material for, for example, secondary batteries.

Though a PFPE having a specific chemical structure is exemplified in the above Examples, the chemical structure of the PFPE is not limited to this. Furthermore, the concentration of the lithium salt in the lithium-ion conductive material is not limited to the specific concentration described above.

As described above, a material containing a specific perfluoropolyether and LiI dissolved in the perfluoropolyether has lithium-ion conductivity and low reactivity with lithium, and is suitable as a lithium-ion conductive material in, for example, a secondary battery.

### DESCRIPTION OF REFERENCE SIGNS

10 positive electrode
11 positive electrode active material layer
12 positive electrode current collector
20 electrolyte layer
30 negative electrode
31 negative electrode active material layer
32 negative electrode current collector
100 secondary battery

1. A lithium-ion conductive material, comprising a perfluoropolyether represented by formula (1) below, and
LiI dissolved in the perfluoropolyether: 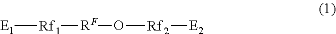
where Rf₁ and Rf₂ are each independently a C₁₋₁₆ divalent alkylene group which may be substituted with one or more fluorine atoms,
E₁ and E₂ are each independently a monovalent group selected from the group consisting of a fluorine group an aldehyde group, and a C₁₋₁₀ alkyl ester group, and
R^{F} is a divalent fluoropolyether group.

2. The lithium-ion conductive material according to claim 1, wherein
R^{F} is a group represented by formula (2): 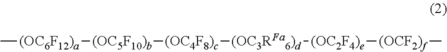
where each R^{Fa} is independently a hydrogen atom, a fluorine atom, or a chlorine atom,
a, b, c, d, e, and f are each independently an integer of 0 to 200,
the sum of a, b, c, d, e, and f is 1 or more,
the order of occurrence of each repeating unit enclosed in parentheses with the subscript a, b, c, d, e, or f is arbitrary in the formula, and
under the proviso that when all R^{Fa} are hydrogen atoms or chlorine atoms, at least one of a, b, c, e, and f is 1 or more.

3. The lithium-ion conductive material according to claim 2, wherein
each R^{Fa} is a fluorine atom.

4. The lithium-ion conductive material according to claim 3, wherein
each R^{F} is independently a group represented by formula (2-1), (2-2), (2-3), (2-4), or (2-5) below: 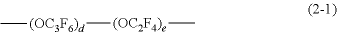
where d is an integer from 1 to 200, and e is 0 or 1; 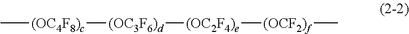
where c and d are each independently an integer of 0 to 30,
e and f are each independently an integer of 1 to 200,
the sum of c, d, e, and f is an integer of 10 to 200, and
the order of occurrence of each repeating unit enclosed in parentheses with the subscript c, d, e or f is arbitrary in the formula; 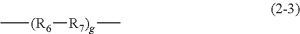
where R₆ is OCF₂ or OC₂F₄,
R₇ is a group selected from OC₂F₄, OC₃F₆, OC₄F₈, OC₅F₁₀, and OC₆F₁₂, or a combination of two or three groups selected from these groups, and
g is an integer of 2 to 100; 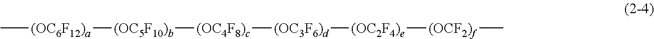
where e is an integer of 1 or more and 200 or less,
a, b, c, d, and f are each independently an integer of 0 or more and 200 or less, and
the order of occurrence of each repeating unit enclosed in parentheses with the subscript a, b, c, d, e, or f is arbitrary in the formula; and 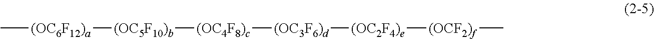
where f is an integer of 1 or more and 200 or less,
a, b, c, d, and e are each independently an integer of 0 or more and 200 or less, and
the order of occurrence of each repeating unit enclosed in parentheses with the subscript a, b, c, d, e, or f is arbitrary in the formula.

5. The lithium-ion conductive material according to claim 4, wherein
each R^{F} is a group represented by formula (2-6) below: 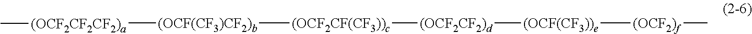
where a, b, c, d, e, and f are each independently an integer of 0 to 200,
the sum of a, b, c, d, e, and f is 1 or more, and
the order of occurrence of each repeating unit enclosed in parentheses with the subscript a, b, c, d, e, or f is arbitrary in the formula.

6. The lithium-ion conductive material according to claim 4, wherein
each R^{F} is a group represented by formula (2-7) below: 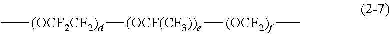
where d, e, and f are each independently an integer of 0 to 200,
the sum of d, e, and f is 1 or more, and
the order of occurrence of each repeating unit enclosed in parentheses with the subscript d, e, or f is arbitrary in the formula.

7. The lithium-ion conductive material according to claim 1, wherein
E₁-Rf₁ and E₂-Rf₂ are each independently a group selected from the group consisting of —CF₃, —CF₂CF₃, and —CF₂CF₂CF₃.

8. A secondary battery, comprising a positive electrode, an electrolyte layer, and a negative electrode, wherein
at least one of the positive electrode, the electrolyte layer, and the negative electrode contains the lithium-ion conductive material according to claim 1.
